(19) United States
(12) Patent Application Publication
(10) Pub. No.: US 2025/0071468 A1
(43) Pub. Date: Feb. 27, 2025

(54) RIE EARPIECE FOR A HEARING DEVICE

(71) Applicant: GN Hearing A/S, Ballerup (DK)

(72) Inventor: Nikolaj CHRISTIANSEN, Valby (DK)

(73) Assignee: GN Hearing A/S, Ballerup (DK)

(21) Appl. No.: 18/797,524

(22) Filed: Aug. 8, 2024

(30) Foreign Application Priority Data
Aug. 23, 2023 (EP) 23193060.3

(51) Int. Cl. H04R 1/10; H04R 1/08; H04R 25/00

(52) U.S. Cl. CPC H04R 1/1075; H04R 1/083; H04R 1/1016; H04R 25/604; H04R 25/65

(57) ABSTRACT

An earpiece for a hearing device and a hearing device is disclosed, the earpiece comprising an earpiece housing for insertion into an ear canal of a user and having a distal end and a proximal end with an earpiece axis therebetween, the earpiece housing having an outer surface connecting the distal end to the proximal end; a receiver comprising a receiver housing, the receiver located within the earpiece housing; and a first microphone configured to pick up ear canal sound, wherein the receiver comprises a moving coil.

### RELATED APPLICATION DATA

This application claims priority to, and the benefit of, European Patent Application No. 23193060.3 filed on Aug. 23, 2023. The entire disclosure of the above application is expressly incorporated by reference herein.

### FIELD

The present disclosure relates to an earpiece for a hearing device and a hearing device.

### BACKGROUND

Earpieces are used in a large variety of situations, where an audio signal is presented to the user via the earpiece. Further, earpieces are used in communication systems for presenting to and/or receiving audio signals from the user.

In two-part hearing devices with an earpiece and an external device, the earpiece is connected to the external device by a cable comprising one or more wires and/or a sound guiding channel.

Earpieces for hearing devices are typically worn for many hours and therefore wearing comfort is of key importance for a hearing device user, especially with the varying ear canal sizes of different users.

### SUMMARY

Accordingly, there is a need for hearing devices/earpieces and methods with improved fit and sound clarity.

An earpiece for a hearing device is disclosed, the earpiece comprising an earpiece housing for insertion into an ear canal of a user and having a distal end and a proximal end with an earpiece axis therebetween, the earpiece housing having an outer surface connecting the distal end to the proximal end; a receiver comprising a receiver housing, the receiver located within the earpiece housing; and a first microphone, e.g. configured to pick up ear canal sound, wherein the receiver optionally comprises a moving coil.

Also, a hearing device comprising a behind-the-ear part and an earpiece as disclosed herein is provided.

It is an important advantage of the hearing device that the hearing device can be of a desirable and comfortable size for the user. Further, the present earpiece/hearing device allows for improved active noise cancellation and/or active occlusion cancellation, e.g. due to improved low frequency performance.

As mentioned, the reduction in size can improve the fit for user's with small ear canals. Previous hearing device solutions allowing for active occlusion may not fit properly in small ear canals, or may extend too far outwards from the ear to make a user not want to wear. In one or more variations of the disclosed hearing device, the device may be more accommodating to those users with smaller ear canals, providing a significant improvement for those users.

Further, it is an important advantage of the earpiece/hearing device that the earpiece/hearing device can be operated for different sound quality over the spectrum of sounds, whether they are received external the ear (such as environmental sound), or inside the ear (such as music playback). Internal and external sound can have their own specific technical problems and solutions, and it can be advantageous for a hearing device to switch between the different types of sound. In one or more variations of the disclosed hearing device, the hearing device can provide advantageous solutions for the two types of audio.

In one or more variations of the disclosed earpiece, the earpiece can provide for the improved sound quality at different audio tone ranges.

Thus, one or more example earpieces and/or hearing devices of the present disclosure allows for improved sizing and/or improved sound clarity.

### BRIEF DESCRIPTION OF THE DRAWINGS

The above and other features and advantages of the present disclosure will become readily apparent to those skilled in the art by the following detailed description of exemplary embodiments thereof with reference to the attached drawings, in which:

FIG. 1 schematically illustrates an example earpiece,

FIG. 2 schematically illustrates an example earpiece,

FIG. 3 schematically illustrates an example earpiece,

FIG. 4 schematically illustrates an example earpiece, and

FIG. 5 schematically illustrates an example earpiece.

### DETAILED DESCRIPTION

Various exemplary embodiments and details are described hereinafter, with reference to the figures when relevant. It should be noted that elements of similar structures or functions are represented by like reference numerals throughout the figures. It should also be noted that the figures are only intended to facilitate the description of the embodiments. They are not intended as an exhaustive description of the invention or as a limitation on the scope of the invention. In addition, an illustrated embodiment needs not have all the aspects or advantages shown. An aspect or an advantage described in conjunction with a particular embodiment is not necessarily limited to that embodiment and can be practiced in any other embodiments even if not so illustrated, or if not so explicitly described.

A hearing device is disclosed. The hearing device may be configured to be worn at an ear of a user and may be a hearable or a hearing aid, wherein the processor is configured to compensate for a hearing loss of a user. The hearing device may be of the behind-the-ear (BTE) type, in-the-ear (ITE) type, in-the-canal (ITC) type, receiver-in-canal (RIC) type, receiver-in-the-ear (RITE) type, and/or microphone-and-receiver-in-ear (MaRie) type.

Specifically, an earpiece for a hearing device is disclosed. The earpiece may be configured to be worn at least partially within an ear canal of a user and may be a hearable or a hearing aid, wherein the processor is configured to compensate for a hearing loss of a user.

As discussed herein, the proximal end of the earpiece or components thereof can herein be seen as the end closest to an ear drum of the user when the earpiece is inserted into the ear of the user. The distal end of the earpiece or components thereof can herein be seen as the end furthest away from an ear drum of the user when the earpiece is inserted into the ear of the user.

In one or more example earpieces for a hearing device, the earpiece may be configured for insertion, such as at least partially, into an ear canal of a user. The earpiece may have a distal end and a proximal end and can include an earpiece axis extending therebetween, e.g. along a length of the earpiece. In other words, the earpiece axis may be a longitudinal axis of the earpiece.

In one or more exemplary earpieces, the earpiece can include an earpiece housing. The earpiece housing may contain and/or accommodate one or more components of the earpiece, such as one or more of receiver, microphone(s) and/or other electronic and/or processing and/or audio and/or data components discussed herein.

The earpiece comprises a receiver. The receiver may include a (receiver) diaphragm also denoted membrane. The receiver can have a receiver housing, e.g. accommodating the diaphragm, the diaphragm separating the inside of the receiver housing in a front cavity and a back cavity. The receiver and/or receiver housing may be fully or partially within the earpiece housing. The receiver may be electrically connected to one or more components in the hearing device, including in the earpiece. The receiver may comprise a moving coil. The receiver may be a dynamic driver also denoted a moving coil receiver. The receiver may comprise a coil, e.g. attached or fixed to the diaphragm of the receiver.

The earpiece may comprise one or more microphones, such as a first microphone and/or a second microphone. For example, the earpiece comprises a first microphone configured to pick up ear canal sound. The first microphone may also be denoted an ear canal microphone.

In one or more examples, the first microphone has a first membrane. The first membrane may be perpendicular or parallel to the earpiece axis. A first membrane normal to the first membrane may form an angle less than 30 degrees with the earpiece axis. A first membrane normal to the first membrane may form an angle in the range from 60 degrees to 90 degrees with the earpiece axis.

In one or more examples, an earpiece for a hearing device is provided, the earpiece comprising an earpiece housing for insertion into an ear canal of a user and having a distal end and a proximal end with an earpiece axis therebetween, the earpiece housing having an outer surface connecting the distal end to the proximal end; a receiver comprising a receiver housing, the receiver located within the earpiece housing; and a first microphone configured to pick up ear canal sound, wherein the receiver comprises a moving coil.

The earpiece may comprise an electronic connector and/or one or more wires extending from the earpiece housing, e.g. to one or more other components or parts of the hearing device outside of the ear canal, such as a behind-the-ear part of the hearing device. In alternative variations, the earpiece may be wirelessly connected to one or more other components outside of the ear canal.

The earpiece housing can have a proximal end (e.g., surface, portion, section, component). The earpiece housing can have a distal end (e.g., surface, portion, section, component). The earpiece housing can have an outer surface (e.g., surface, portion, section, component). The outer surface of the earpiece housing can connect the distal end to the proximal end. In one or more exemplary earpieces, the distal end and/or proximal end and/or connecting surface may be integrally formed. Alternatively, they may be separate components attached to one another, such as through mechanical or chemical attachment. The earpiece housing may be metal and/or plastic. The earpiece housing may be flexible. The earpiece housing may be rigid. The earpiece housing, such as the proximal end, may have a sound port. The sound port may be configured as a sound outlet, or an outlet for sound to direct sound to a user's ear drum. The sound port may be configured as a sound inlet, or an inlet for sound to direct sound from the ear canal into the earpiece housing, e.g. to the first microphone in the earpiece housing. The earpiece housing may comprise a spout, e.g. at the proximal end. The sound port may be arranged in the spout.

The earpiece housing, e.g. in or at the distal end, may include a microphone inlet configured to allow or direct sound from the surroundings to the second microphone.

The earpiece housing, e.g. in or at the distal end, may include an aperture (e.g., hole, empty space, opening, gap) for receiving a wire connected to another component of the hearing device. The distal end may not have an aperture.

In one or more exemplary earpieces, the outer surface may extend (or generally extend) along an earpiece axis, such as the longitudinal axis, of the earpiece. In alternative earpieces, the outer surface may extend at an angle from the longitudinal axis of the earpiece. In some earpieces, the outer surface may include a number of components extending towards and/or away and/or along the longitudinal axis of the earpiece. Thus, the outer surface may have a regular or irregular surface. The outer surface can extend around an entire circumference of the earpiece housing. The outer surface can be any outer surface of the earpiece housing outside of the proximal end and the distal end. The outer surface may include ridges and/or gaps and/or slots and/or mating features. For example, the outer surface may mate with one or more of the domes as discussed herein. In one or more examples, the outer surface may at least along a part of the longitudinal axis have a four-sided cross-section, e.g. with rounded corners.

The earpiece housing may have tabs and/or extensions and/or cavities and/or receiving surfaces and/or attaching surfaces and/or mating surfaces on an inner surface of the earpiece housing (such as on an inner surface of the proximal end and/or distal end and/or outer surface) for connecting the earpiece housing to further components of the earpiece and/or hearing device. The earpiece housing may have tabs and/or extensions and/or cavities and/or receiving surfaces and/or attaching surfaces and/or mating surfaces on an outer surface of the earpiece housing (such as on an outer surface of the proximal end and/or distal end and/or outer surface) for connecting the earpiece housing to further components of the earpiece and/or hearing device. For example, the earpiece housing may mate with one or more of the domes as discussed herein. Further, earpiece housing may include other components, such as a sound tube.

The earpiece housing may have electrical connections on an inner surface of the earpiece housing (such as on an inner surface of the proximal end and/or distal end and/or outer surface) for electrically connecting the earpiece housing to further components of the earpiece and/or hearing device. The earpiece housing may have electrical connections on an outer surface of the earpiece housing (such as on an outer surface of the proximal end and/or distal end and/or outer surface) for electrically connecting the earpiece housing to further components of the earpiece and/or hearing device.

The earpiece housing may contain one or more computer components for operating the earpiece. For example, power storage components and/or one or more processors and/or one or more microchips and/or one or more digital signal processors and/or circuit boards and/or wiring may be partially or fully contained within the earpiece housing.

In one or more exemplary earpieces, the earpiece housing may have a circular (or generally circular or substantially circular) cross section perpendicular to the longitudinal axis. In one or more exemplary earpieces, the earpiece housing may have an ovaloid (or generally ovaloid or substantially ovaloid) cross section perpendicular to the longitudinal axis. In one or more exemplary earpieces, the earpiece housing may have a rectangular (or generally rectangular or substantially rectangular) cross section perpendicular to the longitudinal axis. If a rectangular cross section is used, the cross section may include rounded corners or alternatively sharp corners. The cross section perpendicular to the longitudinal axis may have other polygonal shapes (symmetrical or asymmetrical) as well, and the particular cross-sectional shape of the earpiece housing is not limiting. Further, the cross section may vary in shape and/or dimensions along a longitudinal length of the earpiece, such as discussed below.

The earpiece may be a receiver-in-ear (RIE) earpiece.

The earpiece housing may have a length less than 20 mm, such as less than 15 mm, e.g. in the range from 5-14 mm, e.g. 8 mm, 9 mm, 10 mm, 11 mm, or 12 mm. The earpiece housing may have a maximum extension perpendicular to the earpiece axis less than 10 mm, such as less than 8 mm or even less than 7 mm. In other words, the earpiece housing may have maximum width and/or height less than 10 mm, such as less than 8 mm or even less than 7 mm.

The receiver and/or receiver housing may have or comprise a receiver outlet, e.g. in an end or a wall of the receiver housing. The receiver may include a spout extending from the receiver housing. The receiver outlet may be arranged in a spout of the receiver and may provide fluid communication between the inside, such as a front cavity, of the receiver housing and outside of the receiver housing. The spout may extend generally proximally from the receiver and/or receiver housing. The spout may remain within the earpiece housing. The spout may extend proximally beyond the earpiece housing. The spout may have a circular or ovaloid cross section, though the particular shape of the spout is not limiting.

The receiver and/or receiver housing may have or comprise a receiver vent, e.g. in an end or a wall of the receiver housing. The receiver vent may provide fluid communication between the inside, such as a back cavity, of the receiver housing and outside of the receiver housing.

In one or more examples, the receiver housing has a first end and a second end with a receiver axis therebetween. The receiver axis and the earpiece axis may form an angle, e.g. less than 10 degrees or in the range from 10 degrees to 80 degrees, such as from 15 degrees to 45 degrees. The receiver axis may be a longitudinal axis of the receiver housing.

The receiver may have a length (distance between first end and second end of receiver housing) in the range from 5 mm to 13 mm, such as in the range from 6 mm to 9 mm. The receiver may have a width (distance between first side and second side of receiver housing) in the range from 2 to 5 mm, e.g. from 3 mm to 4 mm. The receiver may have a height (distance parallel to the diaphragm) less than 4 mm, such as in the range from 1 mm to 3 mm.

In one or more examples, the earpiece comprises a second microphone configured to pick up sound from the surroundings, such as sound external to the ear canal. The second microphone may be denoted an ambient microphone. The second microphone may pick up sound via a microphone inlet in the earpiece housing.

In one or more examples, the earpiece housing comprises a sound port at the proximal end, wherein the sound port is in fluid communication with a receiver outlet in the receiver housing. The sound port may be in fluid communication with the first microphone.

In one or more examples, the earpiece housing comprises a vent opening, wherein the vent opening is in fluid communication with a receiver vent in the receiver housing.

In one or more examples, the first microphone is arranged between the receiver and the proximal end of the earpiece housing. In other words, the first microphone may be proximal to the receiver. Generally, the first microphone is arranged close to or within short distance of the sound port to be able to precisely pick up sound or audio from the ear canal. In one or more examples, the first microphone is arranged in a proximal part of the earpiece housing, e.g. within 4 mm from the proximal end of the earpiece housing.

In one or more examples, the earpiece comprises a seal between the receiver housing and an inner surface of the earpiece housing, the seal configured to seal a proximal acoustic chamber of the earpiece from a distal acoustic chamber of the earpiece. In other words, the earpiece housing may be separated, e.g. by the seal and the receiver, in a proximal acoustic chamber on a proximal side of the earpiece and a distal acoustic chamber on a distal side of the earpiece. In one or more examples, the seal may comprise a venting mechanism.

In one or more examples, the earpiece comprises a wire extending from the distal end of the earpiece housing, the earpiece comprising a connector at a distal end of the wire for connecting the earpiece to a behind-the-ear part.

In one or more examples, the earpiece comprises a dome attached to the earpiece housing, such as a spout of the earpiece housing. The dome is configured to support the earpiece housing when inserted in the ear canal by contacting an inner surface of the ear canal. The dome may comprise a vent or be configured to seal the ear canal between the surface of the ear canal and the outer surface of the earpiece housing.

In one or more example earpieces, the receiver housing may have an outer surface. The outer surface or at least a part thereof may be adjacent to and in contact with an inner surface of the earpiece housing. The receiver housing may have an outer surface(s) which may be sized and/or configured to conform with an inner surface(s) of the earpiece housing.

Discussed above are one or more example earpieces which include one or more microphones and a receiver comprising a moving coil.

In any of the above-discussed exemplary earpieces, the earpiece can include one or more domes (e.g., circle, oval, skirts, cones, holders, fitters) extending radially away from the outer surface of the earpiece housing. The one or more domes may extend partially or fully around an outer circumference of the earpiece housing and/or components extending from the earpiece housing. The one or more domes can be integrally formed with the earpiece housing and/or components extending from the earpiece housing. Alternatively, the one or more domes can be attached to the earpiece housing and/or components extending from the earpiece housing. For example, they can be attached to the outer surface. Alternatively, they can be attached to the proximal end and/or the distal end. Alternatively, they can be attached to the outer surface and/or the distal end and/or the proximal end. The one or more domes may extend proximally and/or distally beyond the earpiece housing and/or components extending from the earpiece housing.

The one or more domes may be flexible. The one or more domes may be rigid. The one or more domes may be formed from plastic and/or silicone. The one or more domes may be configured to press against an inner surface of a user's ear canal. The one or more domes can conform to a user's ear canal. Thus, the one or more domes may provide a fit and/or a seal for an earpiece in the user's ear canal. This can prevent unwanted motion of the earpiece within the owner's ear. The one or more domes may be generally circular and/or ovaloid in cross-sectional shape. In one or more exemplary earpieces, the one or more domes can be conically formed, such as opening in a proximal direction. In one or more exemplary earpieces, the one or more domes can be conically formed, such as opening in a distal direction.

In one or more exemplary earpieces, the earpiece can include a first dome (e.g., first skirt or first cone). The first dome can be located proximal to the first set of first vent apertures. The first dome can help to secure the earpiece in the ear canal. The first dome can have an inner surface. The inner surface can extend circumferentially along the outer surface of the earpiece housing. Thus, the first dome can be connected to the earpiece housing. Alternatively, the first dome may be integrally formed with the earpiece housing.

In one or more exemplary earpieces, the first dome has a vent aperture. The vent aperture can be through the first dome for provision of fluid communication. For example, the vent aperture can be through a longitudinal thickness of the first dome. Thus, the vent aperture can provide for provision of fluid communication between a proximal side and a distal side of the first dome. In alternative variations, the first dome can have a plurality of vent apertures, for example, 2, 3, 4, 5, 6 vent apertures. The plurality of vent apertures may be spaced around the first dome. The plurality of vent apertures may be asymmetrically spaced around the first dome. The plurality of vent apertures may be symmetrically spaced around the first dome. Advantageously, the use of the dome with one or more vent apertures can provide for a larger air volume than what would be found in the earpiece housing. Thus, sound quality of the hearing device can be improved.

The vent aperture may have the same dimensions through the thickness of the first dome. Alternatively, the vent aperture may vary in dimensions throughout the thickness of the first dome. Alternatively, the first dome may not have any vent apertures. Specifically, the first dome can prevent fluid communication between a proximal side and a distal side of the first dome between the outer surface of the earpiece housing and an ear canal surface.

In one or more exemplary earpieces, the earpiece can further include a second dome (e.g., second skirt or second cone). The second dome can be located distal to the first dome. The second dome can assist in securing the earpiece in the ear canal. The second dome can have an inner surface extending circumferentially along the outer surface of the earpiece housing. Thus, the second dome can be connected to the earpiece housing. Alternatively, the second dome may be integrally formed with the earpiece housing.

The second dome may prevent fluid communication across a longitudinal thickness of the second dome. Thus, the second dome may not include a vent aperture, or any other aperture providing fluid communication across the second dome. Specifically, the second dome can prevent fluid communication between a proximal side and a distal side of the second dome between the outer surface of the earpiece housing and an ear canal surface.

In one or more exemplary earpieces, the second dome can be located distal to the first set of first vent apertures. In one or more exemplary earpieces, the second dome can be located proximal to the second set of second vent apertures. In one or more exemplary earpieces, the second dome can be located longitudinally between the first primary vent aperture (or the first set of first vent apertures) and the second primary vent apertures (or the second set of second primary vent apertures). Thus, opening and closing of the vent mechanism can prevent fluid flow through or around the earpiece for improving sound quality.

The second dome can have a larger dimension extending away from the earpiece housing than the first dome. The second dome can have the same extension away from the earpiece housing as the first dome. The second dome can extend away from the earpiece housing in a dimension less than the first dome. For example, if the second dome was located on the distal section and the first dome was located on the proximal section, and the distal section had a diameter greater than the proximal section, the first dome would need to have a greater dimension than the second dome.

In one or more example earpieces, the first dome and the second dome are separate. In certain variations, both the first dome and the second dome prevent fluid flow through the domes. In one or more example earpieces, the first dome and the second dome can be connected, thereby forming a combined dome. For example, the first dome and the second dome can be connected by a cylindrical part.

In one or more example earpieces, a combined dome can include multiple dome parts, such as a first dome part and a second dome part. The combined dome can include further dome parts as well, such as a third, fourth, or fifth dome part. The first dome part can be proximal to the second dome part. The first dome part may overlap the second dome part in the longitudinal direction. The first dome part may not overlap the second dome part in the longitudinal direction.

The hearing device may be configured for wireless communication with one or more devices, such as with another hearing device, e.g. as part of a binaural hearing system, and/or with one or more accessory devices, such as a smartphone and/or a smart watch. The hearing device optionally comprises an antenna for converting one or more wireless input signals, e.g. a first wireless input signal and/or a second wireless input signal, to antenna output signal(s). The wireless input signal(s) may origin from external source(s), such as spouse microphone device(s), wireless TV audio transmitter, and/or a distributed microphone array associated with a wireless transmitter. The wireless input signal(s) may origin from another hearing device, e.g. as part of a binaural hearing system, and/or from one or more accessory devices.

The hearing device, such as the earpiece or the behind-the-ear part, optionally comprises a radio transceiver coupled to the antenna for converting the antenna output signal to a transceiver input signal. Wireless signals from different external sources may be multiplexed in the radio transceiver to a transceiver input signal or provided as separate transceiver input signals on separate transceiver output terminals of the radio transceiver. The hearing device and/or earpiece may comprise a plurality of antennas and/or an antenna may be configured to be operate in one or a plurality of antenna modes. The transceiver input signal optionally comprises a first transceiver input signal representative of the first wireless signal from a first external source.

The hearing device, such as the earpiece or the behind-the-ear part, optionally comprises a pre-processing unit. The pre-processing unit may be connected to the radio transceiver for pre-processing the transceiver input signal. The pre-processing unit may be connected the first microphone for pre-processing the first microphone input signal. The pre-processing unit may be connected the second microphone if present for pre-processing the second microphone input signal. The pre-processing unit may comprise one or more A/D-converters for converting analog microphone input signal(s) to digital pre-processed microphone input signal(s).

The hearing device, such as the earpiece or the behind-the-ear part, comprises a processor for processing input signals, such as pre-processed transceiver input signal and/or pre-processed microphone input signal(s). The processor provides an electrical output signal based on the input signals to the processor. Input terminal(s) of the processor are optionally connected to respective output terminals of the pre-processing unit. For example, a transceiver input terminal of the processor may be connected to a transceiver output terminal of the pre-processing unit. One or more microphone input terminals of the processor may be connected to respective one or more microphone output terminals of the pre-processing unit.

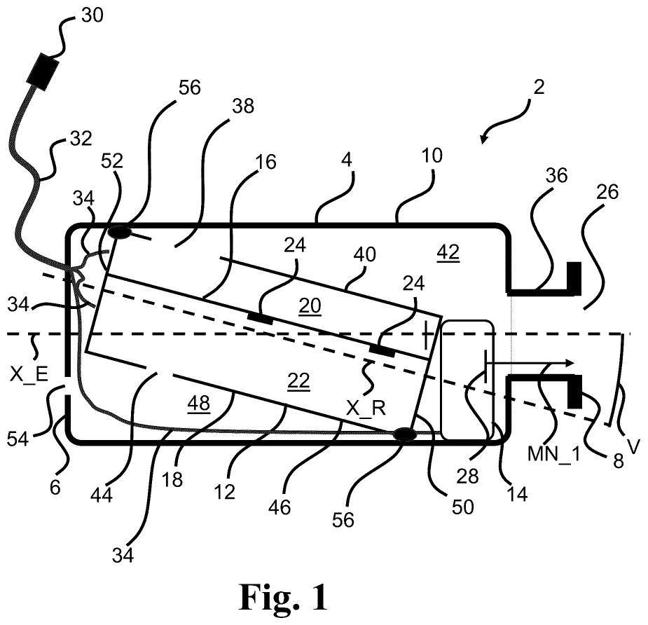

FIG. 1 shows a cross-section of an example earpiece for a hearing device. The earpiece 2 comprises an earpiece housing 4 configured for insertion, such as fully or at least partially, into an ear canal of a user. The earpiece housing 4 has a distal end 6 and a proximal end 8 and includes an earpiece axis X_E therebetween. The earpiece housing 4 has an outer surface 10 connecting the distal end 6 to the proximal end 8 along a length of the earpiece 2. The earpiece housing 4 may contain and/or accommodate one or more components of the earpiece 2, such as one or more of receiver 12, first microphone 14 and/or other electronic and/or processing and/or audio and/or data components.

The earpiece 2 comprises a receiver 12. The receiver 12 comprises a (receiver) diaphragm 16 and a receiver housing 18 accommodating the diaphragm 16 the diaphragm 16 separating the inside of the receiver housing 18 in a front cavity 20 and a back cavity 22. The receiver 12 is a moving coil receiver and comprises a moving coil as a coil 24 attached or fixed to the diaphragm 16.

The earpiece 2 comprises one or more microphones including a first microphone 14 being an ear canal microphone configured to pick up ear canal sound from the ear canal via a sound port 26 in the proximal end 8 of the receiver housing 4. The sound port 26 is configured as a sound outlet for sound from the receiver to direct sound to a user's ear drum. Further, the sound port 26 is configured as a sound inlet for sound from the ear canal into the earpiece housing to the first microphone 14. The earpiece housing 4 comprises a spout 36 at the proximal end 8 with the sound port 26 arranged in the spout 36. The spout 36 is configured for attaching or arrange a dome on the spout. The dome (not shown) may be a dome as described herein.

The first microphone 14 has a first membrane 28 having a first membrane normal MN_1. The first membrane 28 is perpendicular or parallel to the earpiece axis X_E, i.e. the first membrane normal is parallel to the earpiece axis. The first membrane may be angled within the earpiece housing 4.

The earpiece 2 optionally comprises an electronic connector 30 and/or a wire 32 extending from the earpiece housing 4, e.g. to a behind-the-ear part of a hearing device. The wire 32 comprises conductors 34 electrically connecting components 12, 14 of the earpiece to the BTE part (not shown).

The earpiece 2 is a receiver-in-ear (RIE) earpiece and has a length less than 20 mm, e.g. in the range from 5-15 mm, e.g. about 11 mm as illustrated.

The receiver housing 18 comprises a receiver outlet 38 in a first sidewall 40 of the receiver housing and provides fluid communication between the front cavity 20 of the receiver housing 18 and outside of the receiver housing, such as proximal acoustic chamber 42 of the earpiece housing. The sound port 26 is in fluid communication with the receiver outlet 38 in the receiver housing 18 and in fluid communication with the first microphone 14.

The receiver housing 18 optionally comprises a receiver vent 44 in a second sidewall 46 of the receiver housing and provides fluid communication between the back cavity 22 of the receiver housing 18 and outside of the receiver housing, such as distal acoustic chamber 48 of the earpiece housing. The earpiece housing 4 comprises a vent opening 54 for venting the distal acoustic chamber 48. The vent opening 54 is in fluid communication with the receiver vent 44 in the receiver housing 18. In other words, the vent opening 54 is configured for venting the back cavity 22 of the receiver 12.

The receiver housing 18 has a first end 50 and a second end 52 with a receiver axis X_R therebetween. The receiver axis X_R and the earpiece axis X_E forms an angle in the range from 10 degrees to 80 degrees, such as from 15 degrees to 45 degrees. The receiver has a length (distance between first end and second end of receiver housing) in the range from 5 mm to 13 mm, such as in the range from 6 mm to 9 mm.

The first microphone 14 is arranged between the receiver 12 and the proximal end 8 of the earpiece housing. Thus, the first microphone 14 is proximal to the receiver 12.

The earpiece 2 comprises a seal 56 between the receiver housing and an inner surface of the earpiece housing, the seal configured to seal the proximal acoustic chamber 42 of the earpiece from the distal acoustic chamber 48 of the earpiece. In other words, the earpiece housing 4 is separated by the seal 56 and the receiver 12 in a proximal acoustic chamber on a proximal side of the earpiece and a distal acoustic chamber on a distal side of the earpiece.

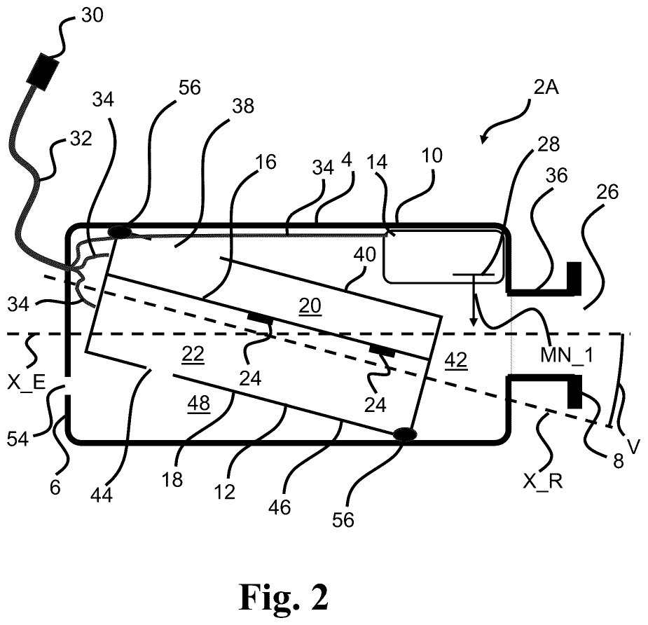

FIG. 2 shows an example earpiece for a hearing device. The earpiece 2A can include all or some of the components or features discussed above with respect to FIG. 1. The first microphone 14 is arranged within 4 mm from the proximal end 8 and has a first membrane 28 parallel to the earpiece axis X_E. In other words, the first membrane 28 has a first membrane normal MN_1 perpendicular to the earpiece axis X_E.

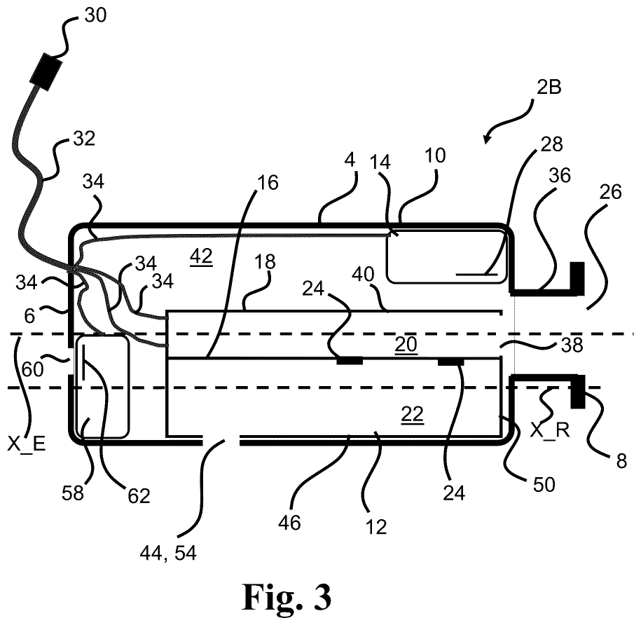

FIG. 3 shows an example earpiece for a hearing device. The earpiece 2B can include all of the components or features discussed above with respect to FIG. 1 or FIG. 2. The receiver is parallel to the earpiece housing and the receiver outlet 38 is arranged in the first end 50 of the receiver housing 18. The back cavity 22 is vented directly through receiver vent 44 and vent opening 44, the vent opening 44 arranged in the outer surface 10.

The earpiece 2B comprises a second microphone 58 being an ambient microphone configured to pick up sound from the surroundings, i.e. sound external to the ear canal, via a microphone inlet 60 in the earpiece housing 4. The second microphone 58 has a second membrane 62 perpendicular or slightly angled to the earpiece axis X_E. It is to be understood that a second microphone as illustrated in earpiece 2B may be implemented in one or both earpieces 2, 2A described above.

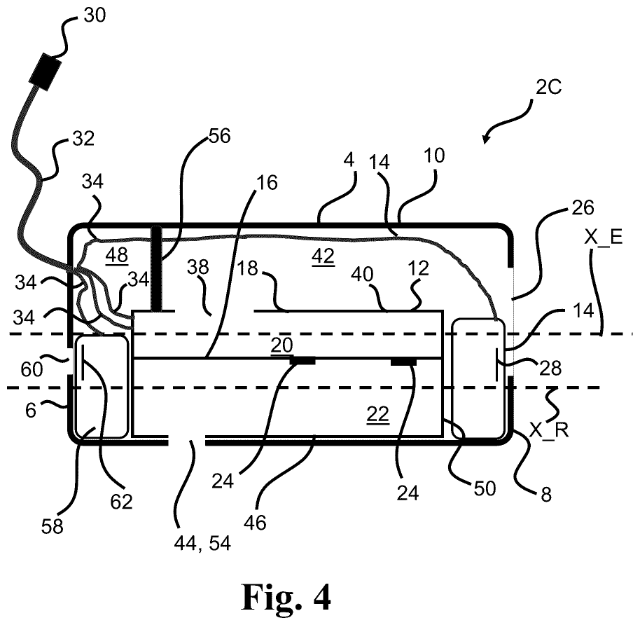

FIG. 4 shows an example earpiece for a hearing device. The earpiece 2C can include all or some of the components or features discussed above with respect to FIG. 1, FIG. 2 and/or FIG. 3. The earpiece 2C optionally comprises seal 56 for forming proximal acoustic chamber 42 and distal acoustic chamber.

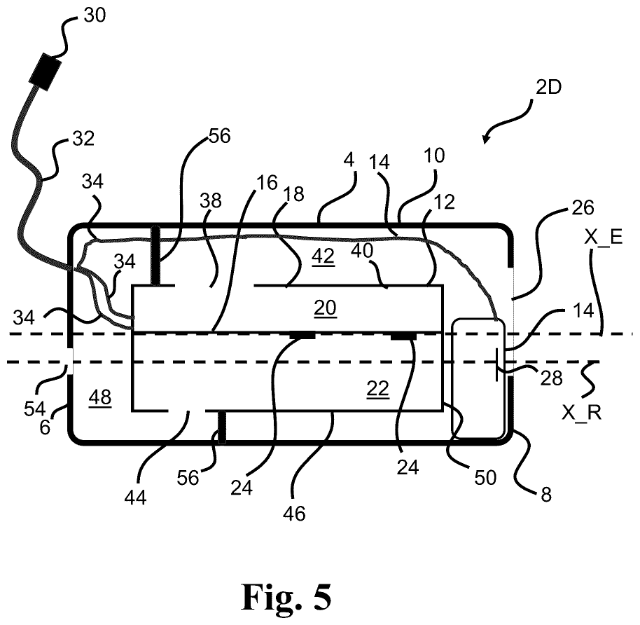

FIG. 5 shows an example earpiece for a hearing device. The earpiece 2D can include all or some of the components or features discussed above with respect to FIG. 1, FIG. 2, FIG. 3 and/or FIG. 4. The earpiece 2D as well as any of earpieces 2, 2A, 2B, 2C may comprise a filter element (not shown) to protect the sound port 26/earpiece e.g. from debris and/or earwax.

The use of the terms “first”, “second”, “third” and “fourth”, “primary”, “secondary”, “tertiary” etc. does not imply any particular order, but are included to identify individual elements. Moreover, the use of the terms “first”, “second”, “third” and “fourth”, “primary”, “secondary”, “tertiary” etc. does not denote any order or importance, but rather the terms “first”, “second”, “third” and “fourth”, “primary”, “secondary”, “tertiary” etc. are used to distinguish one element from another. Note that the words “first”, “second”, “third” and “fourth”, “primary”, “secondary”, “tertiary” etc. are used here and elsewhere for labelling purposes only and are not intended to denote any specific spatial or temporal ordering.

Furthermore, the labelling of a first element does not imply the presence of a second element and vice versa.

It may be appreciated that the figures comprise some modules or operations which are illustrated with a solid line and some modules or operations which are illustrated with a dashed line. The modules or operations which are comprised in a solid line are modules or operations which are comprised in the broadest example embodiment. The modules or operations which are comprised in a dashed line are example embodiments which may be comprised in, or a part of, or are further modules or operations which may be taken in addition to the modules or operations of the solid line example embodiments. It should be appreciated that these operations need not be performed in order presented. Furthermore, it should be appreciated that not all of the operations need to be performed. The exemplary operations may be performed in any order and in any combination.

It is to be noted that the word “comprising” does not necessarily exclude the presence of other elements or steps than those listed.

It is to be noted that the words “a” or “an” preceding an element do not exclude the presence of a plurality of such elements.

It should further be noted that any reference signs do not limit the scope of the claims, that the exemplary embodiments may be implemented at least in part by means of both hardware and software, and that several “means”, “units” or “devices” may be represented by the same item of hardware.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately”, “about”, “generally,” and “substantially” may refer to an amount that is within less than or equal to 10% of, within less than or equal to 5% of, within less than or equal to 1% of, within less than or equal to 0.1% of, and within less than or equal to 0.01% of the stated amount. If the stated amount is 0 (e.g., none, having no), the above recited ranges can be specific ranges, and not within a particular % of the value. For example, within less than or equal to 10 wt./vol. % of, within less than or equal to 5 wt./vol. % of, within less than or equal to 1 wt./vol. % of, within less than or equal to 0.1 wt./vol. % of, and within less than or equal to 0.01 wt./vol. % of the stated amount.

Although features have been shown and described, it will be understood that they are not intended to limit the claimed invention, and it will be made obvious to those skilled in the art that various changes and modifications may be made without departing from the spirit and scope of the claimed invention. The specification and drawings are, accordingly to be regarded in an illustrative rather than restrictive sense. The claimed invention is intended to cover all alternatives, modifications, and equivalents.

### LIST OF REFERENCES

2, 2A, 2B, 2C, 2D earpiece
4 earpiece housing
6 distal end
8 proximal end
10 outer surface
12 receiver
14 first microphone
16 receiver diaphragm
18 receiver housing
20 front cavity
22 back cavity
24 coil, moving coil
26 sound port
28 first membrane
30 connector
32 wire
34 conductor
36 spout
38 receiver outlet
40 first sidewall
42 proximal acoustic chamber
44 receiver vent
46 second sidewall
48 distal acoustic chamber
50 first end
52 second end
54 vent opening
56 seal
58 second microphone
60 microphone inlet
62 second membrane
V angle between earpiece axis and receiver axis
XE earpiece axis
X_R receiver axis

1. An earpiece for a hearing device, the earpiece comprising:
an earpiece housing for insertion into an ear canal of a user, the earpiece housing having a distal end, a proximal end, and an earpiece axis extending between the distal end and the proximal end, the earpiece housing having an outer surface extending between the distal end and the proximal end;
a receiver comprising a receiver housing, the receiver located within the earpiece housing; and
a first microphone configured to pick up sound in the ear canal;
wherein the receiver comprises a moving coil.

2. The earpiece according to claim 1, further comprising a second microphone configured to pick up sound from a surrounding of the user.

3. The earpiece according to claim 1, the earpiece housing comprising a sound port at the proximal end, wherein the sound port is in fluid communication with a receiver outlet of the receiver.

4. The earpiece according to claim 1, the earpiece housing comprising a vent opening, wherein the vent opening is in fluid communication with a receiver vent of the receiver.

5. The earpiece according to claim 1, wherein the first microphone has a first membrane perpendicular or parallel to the earpiece axis.

6. The earpiece according to claim 1, wherein the first microphone is between the receiver and the proximal end of the earpiece housing.

7. The earpiece according to claim 1, wherein the receiver housing has a first end, a second end, and a receiver axis extending between the first end and the second end, the receiver axis and the earpiece axis forming an angle that is anywhere from 10 degrees to 80 degrees.

8. The earpiece according to claim 1, further comprising a seal between the receiver housing and an inner surface of the earpiece housing, the seal configured to seal a proximal acoustic chamber of the earpiece from a distal acoustic chamber of the earpiece.

9. The earpiece according to claim 1, further comprising:
a wire extending from the distal end of the earpiece housing; and
a connector at a distal end of the wire for connecting the earpiece to a behind-the-ear part.

10. The earpiece according to claim 1, further comprising a dome configured to attach to a spout of the earpiece housing.

11. A hearing device comprising a behind-the-ear part and an earpiece according to claim 1.
